(19) United States
(12) Patent Application Publication
(10) Pub. No.: US 2007/0045350 A1
(43) Pub. Date: Mar. 1, 2007

(54) Foam pump

(76) Inventor: Tianda Lin, Zhongsan City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/404,407

(22) Filed: Apr. 14, 2006

(30) Foreign Application Priority Data
Aug. 30, 2005 (CN) 200520063695.4

(51) Int. Cl. G01F 11/00

(52) U.S. Cl. 222/321.9

(57) ABSTRACT

The present invention relates to foam pumps, and especially to a pressing pumping foam pump comprising: a cylinder body comprising an emulsion cylinder and an air cylinder, a pressing head, a sleeve pipe, and a spring. the air cylinder and the emulsion cylinder are connected. The locating post, the sleeve pipe and the valve seat are connected to locate the pressing head. In addition, the lower valve leaf and the upper valve leaf are directly defined on the valve seat to form an air-in check valve and an air-out check valve respectively. The present invention has a simple structure and low costs.

### BACKGROUND OF THE INVENTION

1. Field of the Invention

The present invention relates to foam pumps, and especially to a pressing pumping foam pump.

2. Description of the Related Art

A typical foam pump of the prior art is made up of a pumping air cylinder and a pumping emulsion cylinder which are communicated with each other in their outlet. The pumping air cylinder comprises an air cylinder body and a piston therein. The air cylinder body has an air in-out check valve. The pumping emulsion cylinder comprises an emulsion cylinder body and a piston. The emulsion cylinder body has an emulsion in-out check valve. The piston of the pumping air cylinder is connected to the piston of the pumping emulsion cylinder. In use, a pressing head is depressed to force the piston of the pumping air cylinder and the piston of the pumping emulsion cylinder to work simultaneously. The pumping emulsion cylinder pumps emulsion into it from a bottle and the pumping air cylinder pumps air into it. The emulsion and the air are mixed to be foam in the outlet and then spurts out. A complex structure and high costs are its disadvantages.

### SUMMARY OF THE INVENTION

An object of the present invention is to provide a foam pump having a simple structure and low costs to solve the problem that foam pumps of the prior art have complex structures and high costs.

The object of the present invention is realized by the following technical solution. The foam pump of the present invention comprises a cylinder body comprising an emulsion cylinder and an air cylinder, a pressing head, a sleeve pipe and a spring. A lower portion of the pressing head slidably contacts an inside surface of the cylinder body. The emulsion cylinder is defined in the centre of the cylinder body and the air cylinder is defined in the periphery of the emulsion cylinder, a bottom of the emulsion cylinder comprising an emulsion-in check valve. Said sleeve pipe slidably contacts an inside surface of the emulsion cylinder. A mandrel is mounted on an upper opening of the sleeve pipe to form an emulsion-out check valve, an emulsion-in switch being defined in a lower portion of the sleeve pipe, a valve seat connecting the sleeve pipe to the pressing head. An air-in check valve is defined between an outside of said valve seat and the pressing head. An air-out check valve is defined between an inside of the valve seat and the pressing head. An air inlet for outside air flowing into the air-in check valve is defined in the pressing head. A bottom of said spring is mounted on the air cylinder, a top portion of said spring being directly or indirectly mounted on the pressing head. Both of said emulsion-out check valve and said air-out check valve are communicated with a nozzle defined on the pressing head.

A locating post is defined between said sleeve pipe and the emulsion cylinder. A locating annulus is defined on a top portion of the locating post and a locating flange is defined on a top opening of the sleeve pipe, the locating annulus and the locating flange corporately forming said emulsion-in switch. A narrow emulsion inlet is defined in the bottom of the emulsion cylinder. A bottom of the locating post could block the emulsion inlet. The bottom of the locating post extends to form a connecting post going across the emulsion inlet. The connecting post comprises a blocking element for blocking the emulsion inlet. Said emulsion inlet, said locating post and said blocking element corporately form said emulsion-in check valve.

Said valve seat comprises an outer pipe. An annular lower valve leaf radially extends from a bottom of the outer pipe. A locating platform corresponding with the lower valve leaf is defined on the pressing head. The lower valve leaf contacts the locating platform of the pressing head to form said air-in check valve. An annular strip contacting an inside surface of the outer pipe of said valve seat is axially defined on said pressing head. An upper valve leaf contacting an inside surface of the annular strip of the pressing head is axially defined on a connecting element of the valve seat which connects with the outer pipe. Several connecting holes are defined in the connecting element which is between the upper valve leaf and the inside surface of the outer pipe to form said air-out check valve.

A lower portion of said spring is mounted on a step of the air cylinder. An upper portion of the spring contacts a bottom of the connecting element of the valve seat and is restricted by the outer pipe of the valve seat.

The blocking element of the locating post is in an inverse umbrella shape. An opening surface of the blocking element could block the emulsion inlet of said emulsion cylinder.

An annular strip is defined under the locating platform of said pressing head. The annular strip is inserted into said cylinder body and could slide up and down in the cylinder body.

An inner pipe of the valve seat comprises a gridding.

A conjunct outlet of said air cylinder and said emulsion cylinder comprises a gridding.

As using the technical solution of the present invention, the air cylinder and the emulsion cylinder are connected. The locating post, the sleeve pipe and the valve seat are connected to locate the pressing head. In addition, the lower valve leaf and the upper valve leaf are directly defined on the valve seat to form an air-in check valve and an air-out check valve respectively. The present invention has a simple structure and low costs.

The present invention will become apparent from the following description of a preferred embodiment of the invention with reference to the accompanying drawings.

### BRIEF DESCRIPTION OF THE DRAWINGS

FIG. 1 is a schematic view of the inner structure of a foam pump according to an embodiment of the present invention; and

FIG. 2 is a schematic view of the embodiment showed in FIG. 1 when the pressing head is depressed.

### DETAILED DESCRIPTION OF THE INVENTION

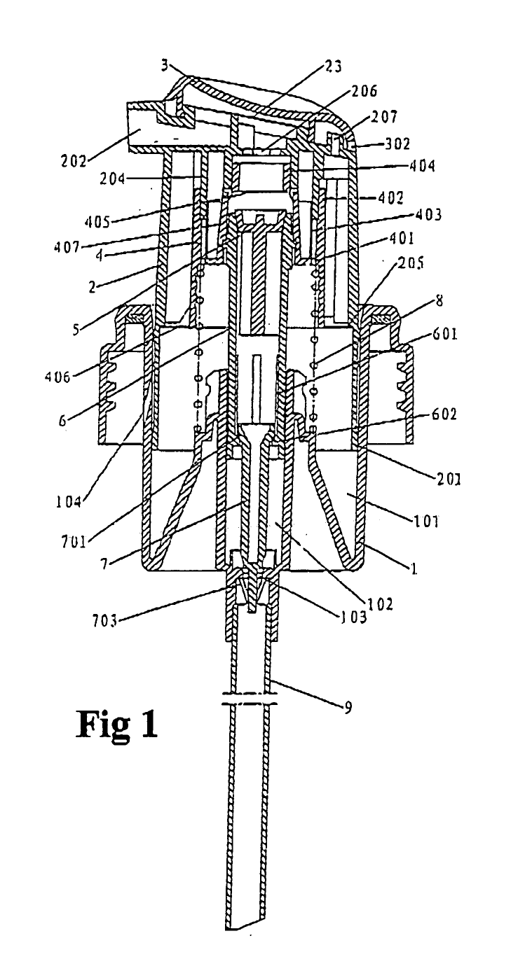

Referring to FIG. 1, a foam pump comprises a cylinder body 1, a pressing head 2, a sleeve pipe 6 and a spring 8. The cylinder body 1 comprises an emulsion cylinder 102 and an air cylinder 101 which is coaxial with the emulsion cylinder 102. A locating platform 205 is defined at a lower portion of the pressing head. An annular strip 201 defined under the locating platform extends into the air cylinder 101. A lower portion of the sleeve pipe 6 slidably extends into the emulsion cylinder 102. An upper end of a locating post 7 comprises a locating annulus 701. The locating annulus 701 and a locating flange 602 on a lower opening of the sleeve pipe 6 corporately form an emulsion-in switch. A head on a lower portion of the locating post 7 and an emulsion inlet 103 on a lower portion of the emulsion cylinder 102 corporately form an emulsion-in check valve. A connecting post on the lower portion of the locating post 7, which extends out of an underside of the emulsion inlet 103, defines a blocking element in an inverse umbrella shape thereon. The blocking element hooks the underside of the emulsion inlet 103. The space among the sleeve pipe 6, a mandrel 5 and the emulsion cylinder 102 forms an emulsion in-out room. A upper portion of the sleeve pipe 6 is fastened in a inner pipe 407 of a valve seat 4. An outer pipe 402 of the valve seat is hermetically fastened to an annular strip 204 of the pressing head. An outer edge of a lower valve leaf 406, which radially extends from a lower end of the valve seat 4, contacts the locating platform 205 of the pressing head. The periphery of an annular upper valve leaf 403, which axially upwardly extends from an upper portion of the valve seat, contacts an inside surface of the annular strip 204. The spring 8 is mounted between the valve seat 4 and the air cylinder 101. It's lower portion is on a step of the air cylinder 101, and its upper portion contacts a bottom of a connecting element of the valve seat and is restricted by the outer pipe of the valve seat.

FIG. 1 shows a state when the pressing head bounces. At this time □ the blocking element 73 on a lower end of the locating post 7 hooks the underside of the emulsion inlet 103. An upper end of the sleeve pipe 6 limits the highest position of the pressing head 2 by the valve seat 4. When the pressing head 2 is depressed, the air in an air in-out room presses the upper valve leaf 403 via a connecting hole 401 of the valve seat to force the upper valve leaf to be separated from the annular strip 204 and form a small clearance between them. The air enters an outlet 206 via the small clearance. The locating post 7 goes downwardly and its head blocks the emulsion inlet 103. The emulsion in the emulsion in-out room flows upwardly via a clearance between the sleeve pipe 6 and the locating annulus 701 and then pushes the mandrel 5 upwardly. The emulsion enters the outlet 206 and is mixed with the air to become foam and then spurts out via a gridding 23 and a nozzle 202. When being released □ the pressing head is reposited upwardly by the elasticity of the spring 8. The mandrel 5 closes an upper opening of the sleeve pipe 6 and the negative pressure created in the emulsion in-out room forces the head of the locating post 7 to be separated from the emulsion inlet 103. The emulsion enters the emulsion in-out room via a pipette 9 and the emulsion inlet 103. And the upper valve leaf 403 close contacts the annular strip 204. The negative pressure created in the air in-out room forces the lower valve leaf 406 to be separated from the locating platform 205. The air enters the air in-out room via an air inlet 302 and a vent hole 207, both of which are defined on the pressing head 2, and a clearance between the lower valve leaf 406 and the locating platform 205. A gridding 405 is connected to the inner pipe 407 of the valve seat by a strip 5. The gridding 23 is connected to the pressing head by pressure or agglutination. A lid 3 is fastened to the pressing head 2. The function of the gridding 405 and 23 is to mix the emulsion and the air adequately.

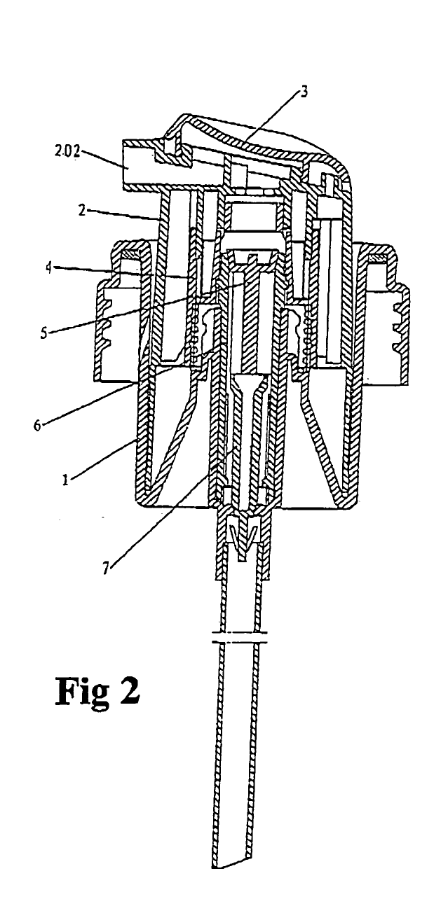

A strip on a lower portion of the mandrel 5 of above embodiment extends into the sleeve pipe 6. On the one hand it could guide the mandrel 5; on the other hand, in assembly, the locating post 7 is put into the sleeve pipe 6 first, then the mandrel 5 is put upon the sleeve pipe 6. The upper portion of the sleeve pipe 6 clips the inner pipe 407 of the valve seat, and then the outer pipe 402 of the valve seat 4 tightly clips the annular strip 204 of the pressing head. Then they are put into the cylinder body 1 together. The pressing head is depressed just like FIG. 2. The locating post 7 is pushed to a lowest position by the strip of the mandrel 5 to let the blocking element 703 extend into the underside of the emulsion inlet 103 and then the assembly is finished.

The present invention has a simple structure and low costs. It is convenient for a mass production.

What is claimed is:

1. A foam pump, comprising:
a cylinder body comprising an emulsion cylinder and an air cylinder;
a pressing head;
a sleeve pipe; and
a spring;
wherein a lower portion of the pressing head slidably contacts an inside surface of the cylinder body, the emulsion cylinder being defined in the centre of the cylinder body and the air cylinder being defined in the periphery of the emulsion cylinder, a bottom of the emulsion cylinder comprising an emulsion-in check valve, said sleeve pipe slidably contacting an inside surface of the emulsion cylinder, a mandrel being mounted on an upper opening of the sleeve pipe to form an emulsion-out check valve, an emulsion-in switch being defined in a lower portion of the sleeve pipe, a valve seat connecting the sleeve pipe to the pressing head, an air-in check valve being defined between an outside of said valve seat and the pressing head, an air-out check valve being defined between an inside of the valve seat and the pressing head, an air inlet for outside air flowing into the air-in check valve being defined in the pressing head, a bottom of said spring being mounted on the air cylinder, a top portion of said spring being directly or indirectly mounted on the pressing head, both of said emulsion-out check valve and said air-out check valve being communicated with a nozzle defined on the pressing head.

2. The foam pump of claim 1, wherein a locating post is defined between said sleeve pipe and the emulsion cylinder, a locating annulus being defined on a top portion of the locating post, a locating flange being defined on a top opening of the sleeve pipe, the locating annulus and the locating flange corporately forming said emulsion-in switch, a narrow emulsion inlet being defined in the bottom of the emulsion cylinder, a bottom of the locating post being used to block the emulsion inlet, the bottom of the locating post extending to form a connecting post going across the emulsion inlet, the connecting post comprising a blocking element for blocking the emulsion inlet, said emulsion inlet, said locating post and said blocking element corporately forming said emulsion-in check valve.

3. The foam pump of claim 2, wherein said valve seat comprises an outer pipe, an annular lower valve leaf radially extending from a bottom of the outer pipe, a locating platform corresponding with the lower valve leaf being defined on the pressing head, the lower valve leaf contacting the locating platform of the pressing head to form said air-in check valve, an annular strip contacting an inside surface of the outer pipe of said valve seat being axially defined on said pressing head, an upper valve leaf contacting an inside surface of the annular strip of the pressing head being axially defined on a connecting element of the valve seat which connects with the outer pipe, several connecting holes being defined in the connecting element which is between the upper valve leaf and the inside surface of the outer pipe to form said air-out check valve.

4. The foam pump of any of the claim 1˜3, wherein a lower portion of said spring is mounted on a step of the air cylinder, an upper portion of the spring contacting a bottom of the connecting element of the valve seat and being restricted by the outer pipe of the valve seat.

5. The foam pump of the claim 4, wherein the blocking element of the locating post is in an inverse umbrella shape and an opening surface of the blocking element could block the emulsion inlet of said emulsion cylinder.

6. The foam pump of the claim 5, wherein an annular strip is defined under the locating platform of said pressing head and the annular strip is inserted into said cylinder body and could slide up and down in the cylinder body.

7. The foam pump of the claim 6, wherein an inner pipe of the valve seat comprises a gridding.

8. The foam pump of the claim 7, wherein a conjunct outlet of said air cylinder and said emulsion cylinder comprises a gridding.
